(19) United States
(12) Patent Application Publication
(10) Pub. No.: US 2004/0185274 A1
(43) Pub. Date: Sep. 23, 2004

(54) Metallic film and image-displaying member

(76) Inventors: Hiroshi Oota, Murayama-city (JP); Tsuneyoshi Saitoh, Higashine-city (JP)

Correspondence Address: 3M INNOVATIVE PROPERTIES COMPANY, PO BOX 33427, ST. PAUL, MN, 55133-3427, US

(21) Appl. No.: 10/664,141

(22) Filed: Sep. 17, 2003

(30) Foreign Application Priority Data
Nov. 8, 2002 (JP) JP 2002-325450

(51) Int. Cl. B32B 5/16

(52) U.S. Cl. 428/457; 428/328

(57) ABSTRACT

A metallic film is provided, with ease and low cost, which can suppress the dependency of the metallic appearance, the luminosity L* and the hue on the observation angle of an observer, using a commonly used metalescent inorganic pigment and a commonly used colorant without modifying the surface of the metalescent inorganic pigment. The metallic film comprises a laminate of a light-transmitting layer and a light-scattering layer, each of which has a first main surface and a second main surface and which are laminated so that the second main surface of the light-transmitting layer faces the first main surface of the light-scattering layer. The light-transmitting layer comprises a polymer and a metalescent inorganic pigment dispersed therein, and the light-scattering layer comprises a polymer and a white colorant dispersed therein.

### RELATED APPLICATION DATA

This application claims priority to JP 2002-325450 filed on Nov. 8, 2002.

### BACKGROUND OF THE INVENTION

1. Field of the Invention

The present invention relates to a metallic film comprising a light-scattering layer containing a white colorant and a light-transmitting layer containing a metalescent inorganic pigment, and an outdoor or indoor image-displaying member comprising such a metallic film.

The metallic film of the present invention can effectively suppress the deterioration of a metallic appearance, luminosity L* and hue caused by the change of an observation angle from a normal direction to a direction deviating from the normal direction, when an observer observes the first main surface of the light-transmitting layer from various directions.

2. Description of the Related Art

Hitherto, many resins and films containing metallic luster agents comprising metal powders or metal foils have been proposed to achieve decorative effects.

For example, JP-A-05-84758 discloses a method for producing a multi-layer film comprising a resinous layer which contains a metallic luster agent or a pearlescent agent. The multi-layer film is produced by simply laminating the resinous layer in which the metallic luster agent or the pearlescent agent is dispersed. Thus, when the film is observed from the direction normal to the film, the desired metallic appearance and luminosity L* can be attained, but when it is observed from a direction other than normal, the light reflection with the metallic luster agent vanishes and therefore the metallic appearance, the luminosity L* or the hue tends to deteriorate.

JP-A-10-28926 discloses a metallic coating film structure in which a low-shielding coating film containing a metallic luster agent is laminated on a gray-color primer film, a solid-color primer film or a metallic primer film. However, the metallic appearance or the luminosity L* of this coating film structure when the film is observed from a direction other than normal is not disclosed. It is reported that this film structure has excellent metallic appearance such that no color difference is caused by the variation of the film thickness.

JP-A-10-17674 discloses a colored resin comprising a thermoplastic resin and a sputtered pigment consisting of a metal material, the surface of which is coated with a pigment by sputtering. This patent application intends to provide a colored resin having a metallic appearance that does not change depending on observation angles at which an observer views the resin.

However, to obtain the above colored resin, the metal material should be covered with the pigment by a sputtering method, in which an inert gas is ionized in a low-pressure or vacuum container filled with the inert gas. In this method, the ions are collided onto a solid surface which is called a target to form target molecules, and then the target molecules are absorbed on the surface of a material placed nearby. Therefore, such a colored resin may not be easily prepared at a low cost.

### SUMMARY OF THE INVENTION

The present invention provides, with ease and low cost, a metallic film, which can suppress the dependency of the metallic appearance, the luminosity L* and the hue on the observation angle of an observer, using a commonly used metalescent inorganic pigment and a commonly used colorant without modifying the surface of the metalescent inorganic pigment.

According to one aspect, the present invention provides a metallic film comprising a laminate of a light-transmitting layer and a light-scattering layer, each of which has a first main surface and a second main surface and which are laminated so that the second main surface of the light-transmitting layer faces the first main surface of the light-scattering layer, wherein

(a) the light-transmitting layer comprises a polymer and a metalescent inorganic pigment dispersed therein, and

(b) the light-scattering layer comprises a polymer and a white colorant dispersed therein.

According to another aspect, the present invention provides an image-displaying member comprising a substrate having a surface and a metallic film as described above. The film is provided on the surface of the substrate with the second main surface of the light-scattering layer facing the surface of the substrate.

Further details of the invention are defined in the features of the claims.

### BRIEF DESCRIPTION OF THE DRAWINGS

FIG. 1 is a schematic cross sectional view of a metallic film according to one embodiment of the present invention.

### DETAILED DESCRIPTION OF THE PREFERRED EMBODIMENTS

The metallic film of the present invention comprises a light-transmitting layer and a light-scattering layer, each of which has first and second main surfaces. The light-transmitting layer comprises a polymer and a metalescent inorganic pigment dispersed therein, and the light-scattering layer comprises a polymer and a white colorant dispersed therein. The two layers are laminated so that the second main surface of the light-transmitting layer faces the first main surface of the light-scattering layer.

Since the light-transmitting layer contains the metalescent inorganic pigment, it has a metallic appearance specific to the metal when the layer is observed from the side of the first main surface of the layer, because the metalescent inorganic pigment reflects light.

Since the light-transmitting layer and the light-scattering layer are laminated to face each other, a part of the light which enters into the light-transmitting layer via its first main surface passes through the light-transmitting layer and then reaches the interface between the light-transmitting layer and the light-scattering layer. Then, the light is scattered on this interface, and a part of the scattered light again enters into the light-transmitting layer via its second main surface and is then reflected by the metalescent inorganic pigment. Accordingly, the metallic film of the present invention can effectively prevent the deterioration of the metallic appearance, the luminosity L* and the hue of the film according to the angles at which the observer sees the metallic film (observation angle), that is, the dependency of these properties on the observation angle.

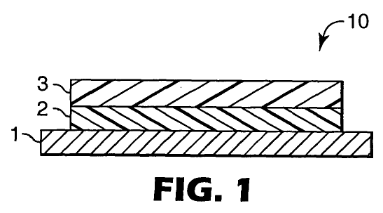

One preferable example of the metallic film of the present invention is explained by making reference to FIG. 1, which schematically shows the cross section of a metallic film according to the present invention. The metallic film (10) comprises the light-scattering layer (2) on the side of the substrate (1) and the light-transmitting layer (3) which is closely laminated to the light-scattering layer with a second main surface of the layer (3) facing a first main surface of the layer (2).

The light-transmitting layer (3) and the light-scattering layer (2) are usually bonded together with an adhesive layer. The adhesive in the adhesive layer is not limited and may be a pressure-sensitive adhesive comprising a self-adherent polymer, a heat-activatable adhesive, a hot-melt adhesive, etc. For example, the adhesive layer containing the pressure-sensitive adhesive can be a single layer of pressure-sensitive adhesive film comprising a self-adherent polymer. The adhesive may be an adhesive curable with actinic radiation or heat. The adhesive layer may contain pigments or dyes so long as the effects of the present invention are not impaired.

The polymer in the light-transmitting layer (3) is preferably a polymer having high transparency and may be polyvinyl chloride, polyurethane, polycarbonate, polyester, polyvinyl acetate, polyolefin, etc. Furthermore, a polymer comprising an epoxy resin or a phenoxy resin may be used.

The polymer in the light-scattering layer (2) is preferably a polymer in which a colorant such as a pigment or a dye can be dispersed at a high concentration and may be a vinyl chloride resin, an acrylic resin, a urethane resin, an olefin resin, etc.

The metalescent inorganic pigment contained in the light-transmitting layer (3) may be flake- or scale-form metal particles. Preferable examples of the metal include aluminum, nickel, silver, etc.

The content of the metalescent inorganic pigment is usually from about 0.1 to about 10.0 parts by weight, preferably from about 0.3 to about 8.0 parts by weight, and more preferably from about 0.5 to about 7.0 parts by weight, based on 100 parts by weight of the polymer in the light-transmitting layer (3). When the amount of the metalescent inorganic pigment is too small, a satisfactory metallic appearance may not be obtained. When the amount of the metalescent inorganic pigment is too large, the amount of light which passes through the light-transmitting layer (3) and reaches the interface between the light-transmitting layer (3) and the light-scattering layer (2) decreases, and as a result the deterioration of the metallic appearance depending on the observation angle cannot be suppressed.

To desirably color the light-transmitting layer (3), the layer (3) may contain a colorant in an amount such that the layer (3) maintains a specific light transmittance.

The colorant to be contained in the light-scattering layer (2) is preferably a pigment. One example of the white colorant is a white pigment. Examples of the pigment include titanium oxide, talc, calcium carbonate, barium sulfate, etc.

The content of the white colorant depends on the kind of the colorant and can be suitably determined so that the luminosity L* of the light-scattering layer (2) is in an optimum range, which will be explained in detail below.

The content of the white colorant is usually from about 5 to about 100 parts by weight, preferably from about 20 to about 80 parts by weight, and more preferably from about 30 to about 70 parts by weight, based on 100 parts by weight of the polymer in the light-scattering layer (2). When the amount of the colorant is too low, the luminosity L* decreases such that the light-scattering performances of the layer tend to deteriorate. When the amount of the colorant is too high, the strength and flexibility of the film may decrease.

Apart from the white colorant, other well-known colorants may be used. For example, phthalocyanine type pigments, quinacridone type pigments, isoindolinone type pigments, lead chromate pigments and the like may be used as pigments, and furthermore carbon black may also be used. The content of the pigment depends on the color intended and may be suitably determined so that the luminosity L* of the light-scattering layer is in an optimum range.

For example, the light-transmitting layer (3) or the light-scattering layer (2) may be prepared as follows:

A composition containing the polymer and the metalescent inorganic pigment or the colorant is applied on the release surface of a process substrate such as a liner and then solidified to form the layer. As an application apparatus, a conventional coater such as a bar coater, a knife coater, a roll coater, a die coater, etc. can be used. “Solidification” means drying in the case of a coating composition containing a volatile solvent, or cooling in the case of a molten polymer.

Alternatively, the light-transmitting layer (3) or the light-scattering layer (2) may be formed by a melt extrusion process.

In general, the light-transmitting layer (3) and the light-scattering layer (2) are separately formed and then adhered with an adhesive, although the coating composition of one layer may be applied on the other layer and then solidified so that the two layers are directly in contact with each other.

The thickness of the light-transmitting layer (3) is usually from about 5 to about 200 μm, preferably from about 10 to about 100 μm, and more preferably from about 30 to about 60 μm. When the thickness of the light-transmitting layer (3) is too low, the metallic appearance may deteriorate. When the thickness of the light-transmitting layer (3) is too high, the light transmittance may decrease.

The thickness of the light-scattering layer (2) is usually from about 5 to about 300 μm, preferably from about 10 to about 100 μm, and more preferably from about 30 to about 60 μm. When the thickness of the light-scattering layer (2) is too low, the opacity and scattering properties of the light scattering layer may deteriorate such that the appearance of the metallic film on the substrate is influenced by the surface of the substrate to which the metallic film is adhered. When the thickness of the light-scattering layer (2) is too high, the flexibility of the film may decrease.

The light transmittance of the light-transmitting layer (3) is preferably from about 20 to about 90%, and more preferably from about 30 to about 80%. When the light transmittance is too high, a sufficient metallic appearance may not be attained. When the light transmittance is too low, the amount of light which passes through the light-transmitting layer (3) and reaches the interface between the light-transmitting layer (3) and the light-shielding layer (2) decreases such that the deterioration of the metallic appearance depending on the observation angle may not be suppressed.

Herein, the “light transmittance” means a total light transmittance, which is measured with a spectrophotometer or a haze meter having a spectrometric function using light having a wavelength of 550 nm.

The luminosity L* of the light-scattering layer (2) is preferably from about 60 to about 98, and more preferably from about 70 to about 95. When the luminosity L* is too high, the light-scattering layer (2) may interfere with the metallic appearance of the metalescent inorganic pigment. When the luminosity L* is too low, sufficient scattering effects may not be attained such that the deterioration of the metallic appearance depending on the observation angle may not be suppressed.

Herein, the “luminosity L*” means a luminosity L* obtained by measuring the surface color with a color meter.

A transparent protective film may be provided on the first main surface of the light-transmitting layer (3). The protective film is preferably a film of a polymer with high transparency. Examples of the polymer of the polymer film include fluorine-containing polymers, phthalate type polyesters (PET, PEN, etc.), acrylic polymers, and the like. The fluorine-containing polymers are those prepared by polymerizing fluorine-containing monomers. A coating film containing a hydrophilizing agent may be formed on the surface of the protective film to impart anti-staining or self-cleaning properties to the protective film.

The thickness of the protective film is preferably from about 5 to about 100 μm.

The substrate can be a sheet, film, plate, etc., which is used to form an image-displaying part of a signboard, but is not limited thereto. The metallic film of the present invention is placed on the surface of the substrate with the second main surface of the light-scattering layer (2) facing the surface of the substrate. The substrate and the metallic film can be bonded with an adhesive.

The image-displaying member produced as above can be used as a structural part of a signboard, a sign, a guideboard, etc.

### EXAMPLES

Hereinafter, the present invention will be illustrated by examples, which do not limit the scope of the invention in any way.

### Example 1

(1) Formation of Light-Transmitting Layer

On a process substrate which had been made releasable, a paste containing a vinyl chloride polymer containing a plasticizer (100 parts by weight), aluminum flakes (3.5 parts by weight) dispersed in the polymer and a colorant (0.03 part) was applied at a dry thickness of 40 μm and then dried to form a light-transmitting layer.

The process substrate used was a polyethylene terephthalate film having a thickness of 50 μm. The aluminum flakes used were “ALPASTE” brand 54-542 (solid content: 70 wt. %) manufactured by Toyo Aluminum K.K. The colorant used was a red colorant, “RT-759” brand manufactured by Ciba Specialities Chemicals K.K.

The light transmittance of this light-transmitting layer was 54%. The method for the measurement of a light-transmittance will be explained below.

(2) Formation of Light-Scattering Layer

In the same manner as in Step (1) except that a paste containing the same vinyl chloride polymer containing the plasticizer (100 parts by weight) as that used in Step (1) and a white pigment (40 parts by weight) dispersed in the polymer was used. The paste was applied on the process substrate at a dry thickness of 40 μm and dried to form a light-scattering layer.

The white pigment used was “Ti-Pure R-960” manufactured by Dupont.

The luminosity L* of this light-scattering layer was 95.

The light-transmitting layer and the light-scattering layer, which were formed in the above steps, were peeled off from the process substrates and then adhered to each other with a transparent acrylic adhesive to provide a metallic film having the structure shown in FIG. 1. The properties of the metallic film were evaluated by the methods described below. The results of the evaluations are shown in Table 1.

### Example 2

A light-transmitting layer was formed in the same manner as in Step (1) of Example 1 except that the amount of the aluminum flakes was changed to 0.7 part by weight and the amount of the colorant was changed to 0.10 part by weight, each based on 100 parts by weight of the vinyl chloride polymer.

The light-transmittance of this light-transmitting layer was 79%.

Next, a light-scattering layer was formed in the same manner as in Step (2) of Example 1 except that a paste containing the same vinyl chloride polymer as above (100 parts by weight), a white pigment (60 parts by weight) and a black pigment (0.1 part by weight) both dispersed in the polymer was used. Here, the white pigment was “Ti-Pure R-960” brand manufactured by Dupont, and the black pigment was “Raven 1200” brand manufactured by Columbian Chemicals.

The luminosity L* of this light-scattering layer was 86.

The light-transmitting layer and the light-scattering layer, which were formed in the above steps, were peeled off from the process substrates and then adhered each other with a transparent acrylic adhesive to provide a metallic film having the structure shown in FIG. 1. The properties of the metallic film were evaluated by the methods described below. The results of the evaluations are shown in Table 1.

### Example 3

A light-transmitting layer was formed in the same manner as in Step (1) of Example 1 except that the amount of the aluminum flakes was changed to 7.0 parts by weight based on 100 parts by weight of the vinyl chloride polymer and no colorant was added.

The light transmittance of this light-transmitting layer was 30%.

Next, a light-scattering layer was formed in the same manner as in Step (2) of Example 1 except that a paste containing the same vinyl chloride polymer as above (100 parts by weight), a white pigment (55 parts by weight) and a black pigment (0.8 part by weight) both dispersed in the polymer was used. The white pigment and the black pigment were the same as those used in Example 2.

The luminosity L* of this light-scattering layer was 73.

The light-transmitting layer and the light-scattering layer, which were formed in the above steps, were peeled off from the process substrates and then adhered to each other with a transparent acrylic adhesive to provide a metallic film having the structure shown in FIG. 1. The properties of the metallic film were evaluated by the methods described below. The results of the evaluations are shown in Table 1.

### Comparative Example 1

The light-transmitting layer was formed in the same manner as in Step (1) of Example 1.

Next, a light-scattering layer was formed in the same manner as in Step (2) of Example 1 except that a paste containing the same vinyl chloride polymer as that used in Step (2) of Example 1 (100 parts by weight) and a black pigment (2.8 part by weight) dispersed in the polymer was used. The black pigment was the same as that used in Example 2.

The luminosity L* of this light-scattering layer was 24.

The light-transmitting layer and the light-scattering layer were peeled off from the process substrates and then adhered to each other with a transparent acrylic adhesive to provide a metallic film. The properties of the metallic film were evaluated by the methods described below. The results of the evaluations are shown in Table 1.

### Comparative Example 2

A light-transmitting layer was formed in the same manner as in Step (1) of Example 1 except that a paste containing the same vinyl chloride polymer as that used in Step (1) of Example 1 (100 parts by weight), aluminum flakes (11.0 parts by weight) and a colorant (0.03 part) (both dispersed in the polymer) were used.

The light transmittance of this light-transmitting layer was 7%.

Next, a light-scattering layer was formed in the same manner as in Step (2) of Example 1.

The light-transmitting layer and the light-scattering layer were peeled off from the process substrates and then adhered to each other with a transparent acrylic adhesive to provide a metallic film. The properties of the metallic film were evaluated by the methods described below. The results of the evaluations are shown in Table 1.

### Comparative Example 3

A light-transmitting layer was formed in the same manner as in Step (1) of Example 1 except that the amount of the aluminum flakes was changed to 0.4 part by weight based on 100 parts by weight of the vinyl chloride polymer and no colorant was added.

The light-transmittance of this light-transmitting layer was 88%.

Next, a light-scattering layer was formed in the same manner as in Step (2) of Example 1 except that a paste containing the same vinyl chloride polymer as above (100 parts by weight), a white pigment (38 parts by weight) and a black pigment (1.3 part by weight) (both dispersed in the polymer) were used. The white pigment and the black pigment were the same as those used in Example 2.

The luminosity L* of this light-scattering layer was 45.

The light-transmitting layer and the light-scattering layer were peeled off from the process substrates and then adhered to each other with a transparent acrylic adhesive to provide a metallic film. The properties of the metallic film were evaluated by the methods described below. The results of the evaluations are shown in Table 1.

### Comparative Example 4

A light-transmitting layer was formed in the same manner as in Step (1) of Example 1 except that the amount of the aluminum flakes was changed to 14.0 parts by weight based on 100 parts by weight of the vinyl chloride polymer.

The light-transmittance of this light-transmitting layer was 17%.

Next, a light-scattering layer was formed in the same manner as in Step (2) of Example 1.

The light-transmitting layer and the light-scattering layer were peeled off from the process substrates and then adhered to each other with a transparent acrylic adhesive to provide a metallic film. The properties of the metallic film were evaluated by the methods described below. The results of the evaluations are shown in Table 1.

Evaluation Methods:

Light Transmittance (%)

A total light transmittance was measured using a haze meter, Haze Meter (trade name) of Nippon Denshoku Industries Co., Ltd.

Luminosity L* (in the Normal Direction)

Using a color difference meter, “Σ90” brand from Nippon Denshoku Industries Co., Ltd, a luminosity of a color was measured under a condition to reflect light in the normal direction on the first main surface of the light-scattering layer itself, or the first main surface of the light-transmitting layer in the metallic film. A D65 light source was used, and the luminosity was measured in a circle area having a diameter of 30 mm.

Color (in the Normal Direction)

A color is judged by visually observing the first main surface of the light-transmitting layer of the metallic layer from the normal direction to the first main surface.

Metallic Appearance (in the Normal Direction or the 60-Degree Direction from the Normal Direction)

The presence of the metallic appearance was judged by visually observing the first main surface of the light-transmitting layer of the metallic film from the normal direction to the first main surface or from a slanted direction deviating from the normal direction by 60 degrees.

Reflection Luminance (cd/m²) (in the Normal Direction or the 60-Degree Direction from the Normal Direction)

A luminance meter (“LS-110” brand from MINOLTA Co., Ltd.) and a pair of 40 W white fluorescent tubes placed apart at a distance of 10 cm were used. A plane to be measured was placed in parallel with the fluorescent tubes at a distance of 2 m from the fluorescent tubes. Then, the luminance on the first main surface of the light-transmitting layer of the metallic film was measured at a distance of 1 m in the normal direction, or in a slanted direction deviating from the normal direction by 60 degrees.

Retention Rate of Reflection Luminance

A retention rate of reflection luminance was calculated from the above-measured reflection luminance values according to the following equation:

Retention rate of reflection luminance (%)=(Luminance in 60 degree deviating direction/luminance in the normal direction)×100

Color Change (from the Normal Direction to the Direction Deviating from the Normal Direction by 60 Degrees)

A color was judged by visually observing the first main surface of the light-transmitting layer or the light-scattering layer from a normal direction, and thereafter the viewing direction was changed to the direction deviating from the normal direction by 60 degrees and the color was judged. Then, it was determined whether there was substantial color change due to the change of angle of the viewing direction.

Discussions of Evaluation Results

From the comparison of the results obtained in the Examples and those obtained in the Comparative Examples, the effects of the close contact of the light-transmitting layer containing the metalescent inorganic pigment to the light-scattering white layer are clearly understood. That is, according to the construction of the present invention, the deterioration of the metallic appearance, the luminosity L* and the hue depending on the observation angle of an observer can be suppressed.

TABLE 1

| | | Ex. 1 | Ex. 2 | Ex. 3 | C. 1 | C. 2 | C. 3 | C. 4 |
|---|---|---|---|---|---|---|---|---|
| Light-transmitting | Aluminum flakes (pbw) | 3.5 | 0.7 | 7.0 | 3.5 | 11.0 | 0.4 | 14.0 |
| layer | Pigment (pbw) | 0.03 | 0.10 | 0 | 0.03 | 0.03 | 0 | 0 |
| | Light transmittance (%) | 54 | 79 | 30 | 54 | 7 | 88 | 17 |
| Light- | White pigment (pbw) | 40 | 60 | 55 | 0 | 40 | 38 | 40 |
| scattering | Black pigment (pbw) | 0 | 0.1 | 0.8 | 2.8 | 0 | 1.3 | 0 |
| layer | Luminosity L* | 95 | 86 | 73 | 24 | 95 | 45 | 95 |
| | (normal direction) | | | | | | | |
| Metallic | Color (normal direction) | Gray | Gray | Gray | Gray | Gray | Gray | Gray |
| film | Metallic appearance | Yes | Yes | Yes | Yes | Yes | Yes | Yes |
| | (normal direction) | | | | | | | |
| | Metallic appearance | Yes | Yes | Yes | No | No | No | No |
| | (60 degree direction) | | | | | | | |
| | Luminosity L* | 78 | 80 | 74 | 68 | 74 | 48 | 77 |
| | (normal direction) | | | | | | | |
| | Reflection luminance (cd/m²) | 247 | 136 | 225 | 249 | 290 | 208 | 287 |
| | (normal direction) | | | | | | | |
| | Reflection luminance (cd/m²) | 76 | 86 | 48 | 22 | 31 | 32 | 47 |
| | (60 degree direction) | | | | | | | |
| | Retention of luminance (%) | 31 | 63 | 25 | 9 | 11 | 15 | 16 |
| | Color change | No | No | No | Yes | Yes | Yes | Yes |
| | (from normal direction to | | | | | | | |
| | 60 degree direction) | | | | | | | |

1. A metallic film comprising a laminate of a light-transmitting layer and a light-scattering layer, each of which has a first main surface and a second main surface and which are laminated so that the second main surface of the light-transmitting layer faces the first main surface of the light-scattering layer, wherein
(a) the light-transmitting layer comprises a polymer and a metalescent inorganic pigment dispersed therein, and
(b) the light-scattering layer comprises a polymer and a white colorant dispersed therein.

2. The metallic film according to claim 1 wherein the light-transmitting layer has a light transmittance of about 20% to about 90%.

3. The metallic film according to claim 1 wherein the light-scattering layer has a luminosity L* of about 60 to about 98.

4. The metallic film according to claim 2 wherein the light-scattering layer has a luminosity L* of about 60 to about 98.

5. The metallic film according to claim 1 wherein the retention rate of reflection luminance is from about 20% to about 90%.

6. The metallic film according to claim 2 wherein the retention rate of reflection luminance is from about 20% to about 90%.

7. The metallic film according to claim 3 wherein the retention rate of reflection luminance is from about 20% to about 90%.

8. An image-displaying member comprising a substrate having a surface and a metallic film according to claim 1 connected to the surface of the substrate, wherein the second main surface of the light-scattering layer faces the surface of the substrate.
